(19) United States
(12) Patent Application Publication
(10) Pub. No.: US 2022/0016727 A1
(43) Pub. Date: Jan. 20, 2022

(54) FORMATION OF SELECTIVELY REINFORCED COMPONENTS

(71) Applicants: Gemma Louise CHRISTIAN, Basingstoke Hampshire (GB); John Richard BONAS, Basingstoke Hampshire (GB)

(72) Inventors: Gemma Louise CHRISTIAN, Basingstoke Hampshire (GB); John Richard BONAS, Basingstoke Hampshire (GB)

(73) Assignee: Alvant Limited, Basingstoke Hampshire (GB)

(21) Appl. No.: 17/299,746

(22) PCT Filed: Nov. 15, 2019
(86) PCT No.: PCT/GB2019/053246

§ 371 Date: Jun. 3, 2021

(30) Foreign Application Priority Data
Dec. 4, 2018 (GB) 1819763.2

(51) Int. Cl. B23K 20/12; B22D 19/14; B22D 19/02

(52) U.S. Cl. CPC B23K 20/122; B22D 19/02; B23K 20/129; B22D 19/14

(57) ABSTRACT

A selectively reinforced component comprises a metal body with at least one metal matrix composite insert embedded in a first surface of the metal body, with at least one weld bonding an outer surface of the metal matrix composite insert to the metal body. The selectively reinforced component is formed by introducing the or each metal matrix composite insert into a recess in the first surface of the metal body, before forming the at least one weld to bond the outer surface of the metal matrix composite insert to an opposing inner peripheral surface of the recess.

### TECHNICAL FIELD

The present invention relates generally to a method of forming a selectively reinforced component, and particularly but not exclusively to such a component with metal matrix composite insert embedded in a metal body. The present invention also relates generally to such a selectively reinforced component, and a metal matrix composite insert for localised reinforcement of a metal body.

### BACKGROUND ART

Metal matrix composites (MMCs) are composed of a metal matrix and a reinforcement, or filler material, which confers excellent mechanical performance, and can be classified according to whether the reinforcement is continuous (monofilament or multifilament) or discontinuous (particle, whisker, short fibre or other). The principal matrix materials for MMCs are aluminium and its alloys. To a lesser extent, magnesium and titanium are also used, and for several specialised applications a copper, zinc or lead matrix may be employed. MMCs with discontinuous reinforcements are usually less expensive to produce than continuous fibre reinforced MMCs, although this benefit is normally offset by their inferior mechanical properties. Consequently, continuous fibre reinforced MMCs are generally accepted as offering the ultimate in terms of mechanical properties and commercial potential.

A basic process for casting fibre reinforced metals is described in U.K. patent specification GB 2115327. As a licensee under the patent, the present applicant developed the basic process into a full scale liquid pressure forming (LPF) process. In the LPF process, a pre-heated preform (fibres, short fibres, porous media or particulate) is placed in a heated die, which is closed and locked using a mechanical toggle system. The die and molten metal in a crucible housed in a pressure vessel are then subjected to a high vacuum. When the evacuation is complete, molten metal is transferred from the crucible into the die through a sprue fed by a riser tube by the introduction of nitrogen gas into the pressure vessel. The molten metal takes up the shape of the die, which can be complex, and largely infiltrates the preform. Once the die is filled with molten metal, a hydraulic compaction piston is used to seal the top of the riser tube and further consolidate the casting to encourage maximum infiltration of the preform and to consolidate the shrinking matrix during metal solidification. The resulting composite is then ejected from the die.

According to leading authorities in the field of materials' science, the LPF process is one of the most efficient and cost-effective methods of manufacturing MMCs, and represents a significance technological advance in the commercialisation of these composite materials. In particular, achieving total cycle times in the range 2 to 5 minutes is one of many significant advantages over other fabrication routes for MMCs. Nevertheless, the present applicant has proposed an advanced liquid pressure forming (ALPF) process, as described in WO 2005/097377 (the entire contents of which are herein incorporated by way of reference), which provides various improvements to the LPF, including a way of increasing the degree of metal infiltration into the perform by applying pressure direct to the molten metal in the die cavity during solidification, and a way of decreasing cycle times using a duplex die.

The present applicant is seeking to develop new ways of using MMCs. Of particular interest are selectively reinforced components comprising a metal matrix composite at least partially embedded in a metal body. One of the difficulties with such a selectively reinforced component is the relatively poor bond strength at the interface between the metal matrix composite and metal body which may give rise to premature failure of the component.

### STATEMENT OF INVENTION

In accordance with a first aspect of the present invention, there is provided a method of forming a selectively reinforced component, comprising: providing a metal body having a recess formed in a first surface thereof; introducing a metal matrix composite insert into the recess, the metal matrix composite insert having a profile configured to fit the recess such that at least one outer surface of the metal matrix composite insert is adjacent an opposing inner peripheral surface of the recess; and forming a weld to bond the at least one outer surface of the metal matrix composite insert to the opposing inner peripheral surface of the recess.

The first surface of the metal body may be substantially planar. The metal body may be substantially plate-like, with regions on opposite lateral sides of the recess having a uniform thickness. The metal matrix composite insert may be a “snug” fit in the recess, to minimise relative movement of the metal matrix composite insert relative to the metal body when forming the weld. For example, the metal matrix composite insert may have a footprint which matches that of the recess with a clearance tolerance of less than 0.5 mm. Furthermore, the metal matrix composite insert and recess may have corresponding profiles. In this way, opposing surfaces are encouraged to abut when the metal matrix composite insert is introduced into the recess. The recess may have a substantially rectangular opening in the first surface of the metal body, and the recess may be shallow compared to the width and the length of the rectangular opening.

In one form, the at least one outer surface of the metal matrix composite insert is part of a surface or marginal region which is metal-rich compared to a core region of the metal matrix composite insert. The core region is spaced from the at least one outer surface of the metal matrix composite insert. The surface or marginal region may even be substantially free of composite reinforcement. In one arrangement, the surface or marginal region may extend to a depth of up to 5 mm below the at least one outer surface of the metal matrix composite insert. In another arrangement, the surface region may only extend to a depth of up to 2 mm, perhaps even about 1 mm, below the at least one outer surface of the metal matrix composite insert.

The metal matrix composite insert may comprise a continuous (monofilament or multifilament) reinforcement. The continuous reinforcement may comprise at least one filament aligned in a common direction which is substantially parallel to the first surface of the metal body when the metal matrix composite insert is introduced into the recess. The metal matrix composite insert may be formed by a LPF process (for example, as described in GB 2115327) or an ALPF process (for example, as described in WO2005/097377). Alternatively, the metal matrix composite may comprise particle reinforcement, and may be formed in a conventional manner.

In one embodiment, forming the weld may comprise friction stir welding. Such welding may comprise introducing a probe of a rotating tool into the metal body though the first surface thereof, adjacent a lateral side of the recess, to form a weld between a side surface of the metal matrix composite insert and the opposing inner peripheral surface of the recess that surrounds the metal matrix composite insert. Such welding may further comprise moving the probe along the lateral side of the recess. Moving the probe whilst forming the weld may comprise tracing at least partially around a perimeter of the recess. Such welding may further comprise maintaining the probe at a constant insertion depth when moving the probe along the lateral side of the recess.

The method may further comprise removing excess material from the weld which projects proud of the first surface. Removing such excess material from the weld may preferably be carried out without jeopardizing the integrity of any continuous fibre reinforcement in the metal matrix composite insert.

Alternatively or additionally, friction stir welding may comprise introducing a probe of a rotating tool into the metal body through a second surface thereof, spaced from and opposite the first surface of the metal body, to form a weld between an underside surface of the metal matrix composite insert and an opposing bottom surface of the recess. The weld between the bottom surface of the recess and the opposing face of the metal matrix composite insert may hereinafter be referred to as the “lower weld”, to distinguish it from the weld joining the outer surface of the metal matrix composite insert to the opposing inner peripheral surface of the recess that surrounds the metal matrix composite insert. Such welding may further comprise moving the probe underneath the recess, from one side of the bottom surface of the recess to another side of the bottom surface of the recess. Such welding may further comprise moving the probe underneath the bottom surface of the recess in such a way that the weld covers substantially the entire bottom surface of the recess. Such welding may further comprise maintaining the probe at a constant insertion depth when moving the probe underneath the recess. The constant insertion depth may be maintained to prevent the probe penetrating the recess.

The method may further comprise covering the first surface of the metal body with a metal plate to conceal the metal matrix composite insert between the metal body and the metal plate, once the metal matrix composite insert has been introduced into the recess. If forming the weld comprises introducing a probe of a rotating tool into the metal body though the first surface thereof, such weld would need to be formed before covering the first surface of the metal body with the metal plate. The method may further comprise welding the metal plate to the metal body and/or the metal matrix composite insert, for example by friction stir welding.

In accordance with a second aspect of the present invention, there is provided a selectively reinforced component comprising a metal body with a metal matrix composite insert embedded in a first surface of the metal body, with at least one weld bonding an outer surface of the metal matrix composite insert to the metal body.

In one embodiment, the at least one weld may comprise a weld formed at the first surface of the metal body and which extends below the first surface of the metal body. The weld may extend below the first surface of the metal body to a depth at least equal to a depth to which the metal matrix composite insert is embedded in the first surface of the metal body. The weld may surround the metal matrix composite insert.

Alternatively or additionally, the at least one weld may comprise a weld formed through a second surface of the metal body, the second surface being spaced from and opposite the first surface, with the weld extending through the metal body to the outer surface of the metal matrix composite which faces the second surface.

In one embodiment, the metal matrix composite insert is embedded in the metal body with an upper surface flush with the first surface of the metal body. The upper surface of the metal matrix composite insert may be covered by a metal plate. The metal plate may be welded to the metal body and/or the metal matrix composite insert.

In one embodiment, the metal matrix composite insert may comprise a continuous (monofilament or multifilament) reinforcement. The continuous reinforcement may comprise at least one filament aligned in a common direction which is substantially parallel to the first surface of the metal body. The first weld may be spaced from the continuous reinforcement to avoid jeopardizing the integrity of the continuous reinforcement. Alternatively, the metal matrix composite may comprise particle reinforcement.

In one embodiment, the metal body is circular, and the metal matrix composite insert comprises a continuous reinforcement, with at least one filament aligned in a radial direction relative to the circular metal body. The metal matrix composite insert may be one of a plurality of metal matrix composite inserts embedded in the first surface of the metal body, with at least one weld bonding an outer surface of each metal matrix composite insert to the metal body. Each of the metal matrix composite inserts may comprise a continuous reinforcement, with at least one filament of each metal matrix composite aligned in a radial direction relative to the circular metal body. The plurality of metal matrix composite inserts embedded in the first surface of the metal body may be evenly spaced in a circumferential direction relative to the circular metal body.

In accordance with a third aspect of the present invention, there is provided a metal matrix composite insert for selectively reinforcing a metal body, the metal matrix composite insert comprising a core region comprising a continuous reinforcement and a surface or marginal region which is metal-rich compared the core region. The surface region may surround the core region in at least one plane. The surface region may be substantially free of filaments and/or fibres. The surface region may extend to a depth of up to 5 mm, at least on one direction from an outer surface of the metal matrix composite insert towards the core region. Preferably, the surface region may extend to a depth of up to 2 mm, perhaps even about 1 mm, below the outer surface of the metal matrix composite insert.

### BRIEF DESCRIPTION OF THE DRAWINGS

An embodiment of the invention will now be described with reference to the accompanying drawings in which:

FIG. 1 shows a perspective view of a selectively reinforced component, embodying the present invention;

FIG. 2 is an enlarged view showing detail of the component of FIG. 1;

FIGS. 3A-3C are schematic, cut-away and sectional illustrations of a metal matrix composite insert used in the selectively reinforced component of FIG. 1;

FIG. 4 illustrates schematically a first friction stir welding process used to form the selectively reinforced component of FIG. 1;

FIGS. 5A-5C illustrate schematically a second friction stir welding process used to form the selectively reinforced component of FIG. 1; and

FIGS. 6A-6D illustrate schematically a further friction stir welding process used to form a modified selectively reinforced component.

### DETAILED DESCRIPTION OF SPECIFIC EMBODIMENT

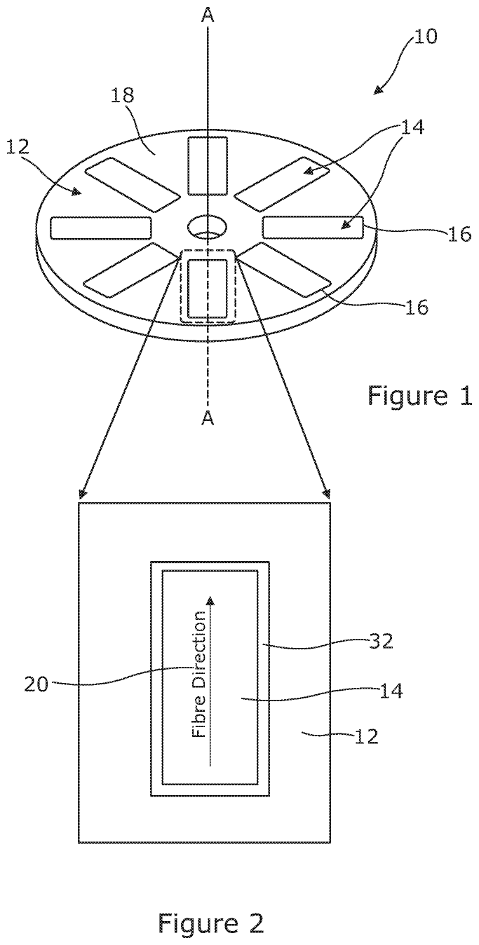

FIGS. 1 and 2 show a selectively reinforced component 10 according to an embodiment of the present invention. The selectively reinforced component 10 is an aluminium electric rotor component comprising a metal body 12 in the form of a circular disc, which is reinforced with eight continuous fibre metal matrix composite (MMC) inserts 14 embedded in respective recesses 16 in a first surface 18 of the metal body 12. Each MMC insert 14 is elongate, with its fibre reinforcement aligned parallel to the longitudinal axis of the MMC insert 14. When embedded in the metal body 12, each MMC insert 14 is oriented such that the direction 20 of its fibre reinforcement is aligned in a radial direction relative to a central axis AA of the metal body 12. Furthermore, when embedded in the metal body 12, the MMC inserts 14 are equally spaced in a circumferential direction relative to the central axis AA of the metal body. Each insert 14 has a metal rich surface region 32 (which is explained in greater detail below) which is metallurgically bonded to the metal body 12 by at least one weld formed by a friction stir welding apparatus 40.

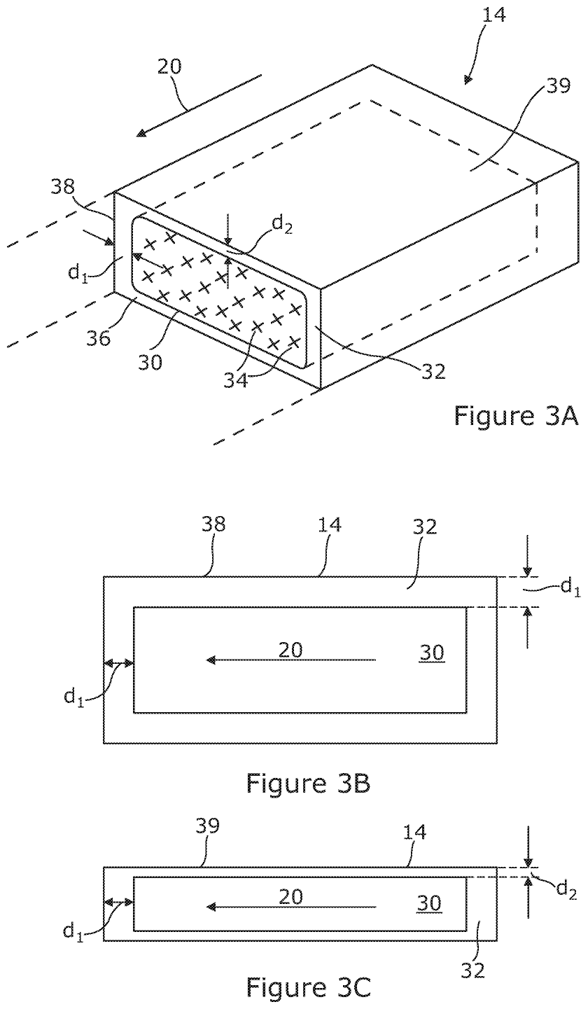

FIG. 3A is a schematic, cut-away illustration of the MMC insert 14 showing a core region 30 which is surrounded and encapsulated by the surface or marginal region 32. The core region 30 comprises a plurality of filaments 34 aligned substantially parallel to the direction 20. A single metal matrix 36 infiltrates and extends throughout both the core region 30 and the surface region 32, providing a seamless transition from one region to the other without a boundary interface therebetween with an inherent weakness, caused for example by an oxide layer which may be found in a conventional physical joint. The surface region 32 is substantially free of reinforcement fibres, and so is metal rich compared to the core region 30. The surface region 32 also covers both longitudinal ends of the MMC insert 14, such that the filaments 34 do not extend the full length of the MMC insert 14. As shown in FIG. 3A, the surface region 32 is deeper at the sides 38 of the MMC insert 14 than at the upper or lower surfaces 39 of the MMC insert 14. The surface region 32 is also deeper at the longitudinal ends of the MMC insert 14 that at the upper or lower surfaces 39 of the MMC insert 14. In a horizontal plane, as shown in FIG. 3B, the surface region 32 at the sides 38 and ends of the MMC insert 14 typically extends to a depth “d₁” of about 1.0 mm or 2.0 mm below the outer surface of the MMC insert 14 in a direction towards the core region 30. In a vertical plane, as shown in FIG. 3C, the surface region 32 at the upper and lower surfaces 39 of the MMC insert 14 typically extends to a depth “d₂” of about 0.5 mm or less below the outer surface of the MMC insert 14 in a direction towards the core region 30.

The MMC insert 14 is formed by the ALPF process (for example, as described in WO2005/097377, the entire content of which is hereby incorporated by reference). In brief, a fibre preform with the filaments 34 is restrained between upper and lower plates which define a mould cavity with a gap around the filaments 34 to allow for formation of the metal-rich surface or marginal region 32. Molten metal is forced under pressure into the mould cavity to infiltrate and embed the filaments in a continuous metal matrix.

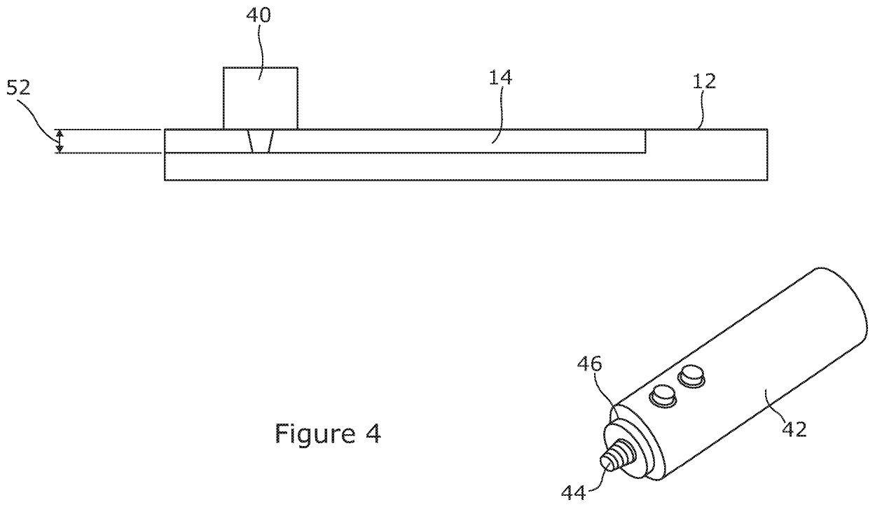

FIG. 4 illustrates schematically a first friction stir welding process used to form the selectively reinforced component of FIG. 1. For completeness, the tool parameters are: tool rotation—550 RPM; welding speed—350 mm/min; position control—−0.1 mm plunge; spindle offset from insert—7.5 mm; probe type—Tri-flute™; shoulder Ø—15 mm. The friction stir welding apparatus 40 comprises a rotating tool 42 with a probe 44 which is introduced into the metal body 12 through the first surface 18, adjacent a lateral side 50 of the recess 16. The probe 44 is introduced into the metal body to a depth 52 governed by a shoulder 46 of the rotating tool. The depth 52 is substantially equal to the thickness of the MMC insert 14 embedded in the metal body 12. The probe 44 is then moved around the recess 16, forming a weld to bond the outer surface 38 of the MMC insert 14 to an inner peripheral surface of the recess 16. When moving the probe 44 around the recess 16, the surface region 32 acts as a physical spacer to prevent the probe 44 interfering with any of the filaments 34 in the core region 30 of the MMC insert 14.

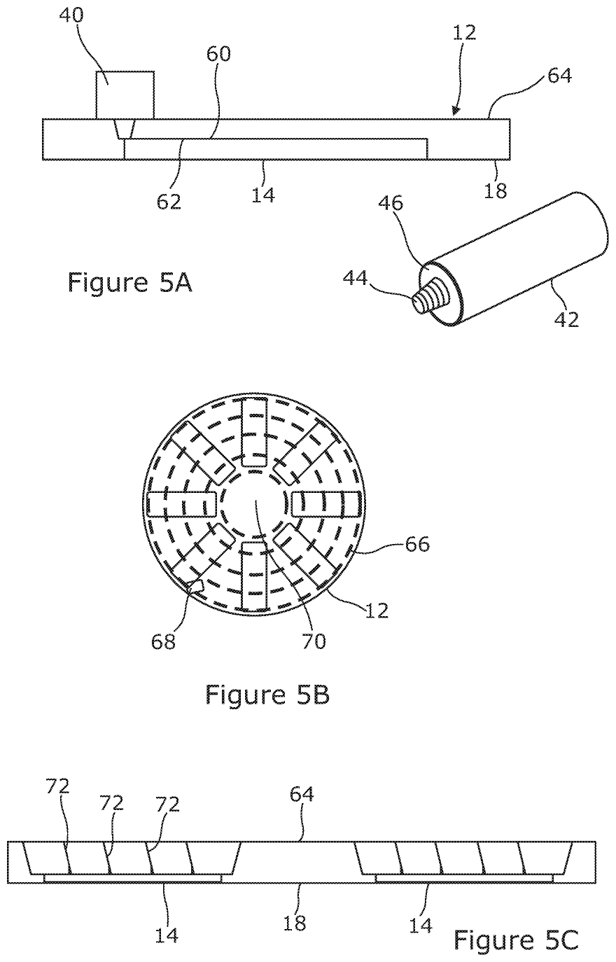

FIGS. 5A-5C illustrate schematically a second friction stir welding process used to form the selectively reinforced component of FIG. 1. For completeness, the tool parameters are: tool rotation—550 RPM; welding speed—350 mm/min; position control—−0.5 mm plunge; spiral overlap—75% of shoulder Ø (10 mm pitch); probe type—Tri-flute™; shoulder Ø—40 mm. The second friction stir welding process uses the same type of apparatus 40 as the first friction stir welding process described above (although probe insertion depths need not be the same), so the same reference numbers are used for features in common. It should be noted however that the qualifiers “first” and “second” do not necessarily indicate any chronology, and that the second friction stir welding process may actually be carried out before the first friction stir welding process described above.

The purpose of the second friction stir welding process is to form at least one weld bonding a bottom surface 60 of the recess 16 to an opposing face 62 of the MMC insert 14 when embedded in the recess 16. This is achieved by introducing the probe 44 of the rotating tool 42 into the metal body 12 through a second or rear surface 64 thereof. The second surface is spaced from an opposite the first surface 18 of the metal body 12. The probe 44 is then moved underneath the recess 16, from one side of the bottom surface 60 of the recess 16 to another side of the bottom surface 60 of the recess 16. The probe 44 may be moved along a pathway 66 in such a way as to build up one or more welds extending across the entire bottom surface 60 of the recess 16. For example, the probe 44 may be moved along a spiral pathway, or decreasing concentric circular pathway, centred on central axis AA of the metal body 12, with the probe 44 starting at an outside edge 68 of the metal body 12 and exiting at a central opening 70. The probe 44 may also be moved in such a way that the one or more welds 72 extending across the entire bottom surface 60 of the recess 16 overlap to some degree to eliminate weak bonds in regions between adjacent portions of the one or more welds 72.

After the first and/or second friction stir welding processes, excess weld material projecting proud of the first and/or second surface of the metal body 12 may be removed, for example by milling, taking care not to damage the filaments 34 of the MMC insert 14.

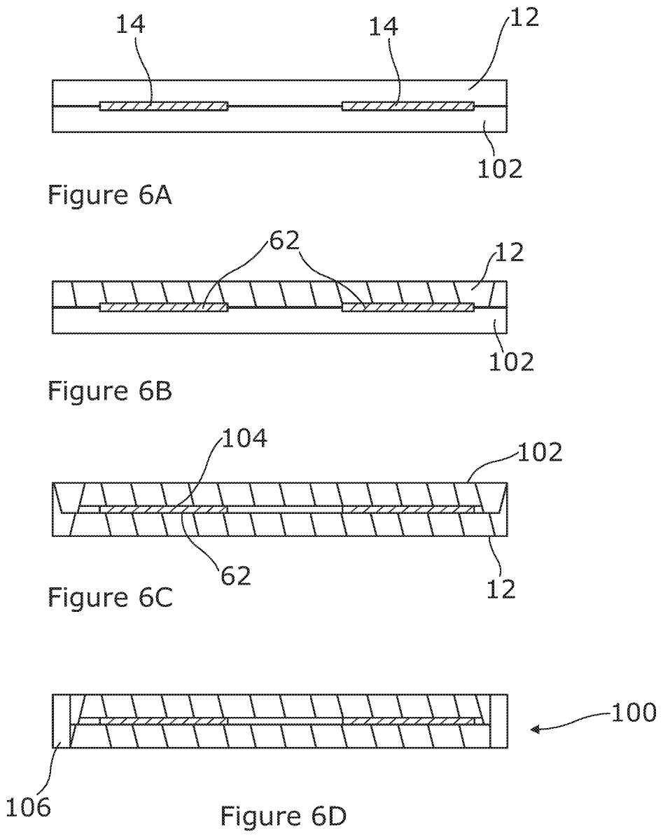

FIGS. 6A-6D illustrate schematically a further friction stir welding process used to form a modified selectively reinforced component 100. Once the MMC inserts 14 have been embedded in the recesses 16 of the metal body 12, and the first friction stir welding process described with reference to FIG. 4 has been completed, the first surface 18 of the metal body 12 may be covered by a metal plate 102 (see FIG. 6A). (In an alternative process, the first friction stir welding process may be omitted altogether.) In this way, the MMC inserts 14 are sandwiched and wholly concealed between the metal body 12 and the metal plate 102. The second friction stir welding process is then used to form at least one weld bonding the bottom surface 60 of the recess 16 to the opposing face 62 of the MMC insert 14 when embedded in the recess 16 (see FIG. 6B). The further friction stir welding process is then used to form at least one weld bonding the metal plate 102 to not only an opposing face 104 of the MMC insert 14 (see FIG. 6C) but also the first surface 18 of the metal body 12. Finally, excess material 106 is machined from the laminated structure to leave the modified selectively reinforced component 100 (see FIG. 6D) resembling one bulk material with the MMC inserts 14 concealed within.

1. A method of forming a selectively reinforced component, comprising:
providing a metal body having a recess formed in a first surface thereof;
introducing a metal matrix composite insert into the recess, the metal matrix composite insert having a profile configured to fit the recess such that at least one outer surface of the metal matrix composite insert is adjacent an opposing inner peripheral surface of the recess; and
forming a weld to bond the at least one outer surface of the metal matrix composite insert to the opposing inner peripheral surface of the recess.

2. A method according to claim 1, in which the at least one outer surface of the metal matrix composite insert is part of a marginal region which is metal-rich compared to a core region of the metal matrix composite insert.

3. A method according to claim 2, in which the marginal region is substantially free of composite reinforcement.

4. A method according to claim 2, in which the marginal region extends to a depth of up to 5 mm below the outer surface of the metal matrix composite insert.

5. A method according to claim 1, in which the metal matrix composite insert comprises a continuous (monofilament or multifilament) reinforcement.

6. A method according to claim 5, in which the continuous reinforcement comprises at least one filament aligned in a common direction which is substantially parallel to the first surface of the metal body when the metal matrix composite insert is introduced into the recess.

7. A method according to claim 1, in which forming the weld comprises friction stir welding.

8. A method according to claim 7, in which friction stir welding comprises introducing a probe of a rotating tool into the metal body though the first surface thereof, adjacent a lateral side of the recess, to form a weld between a side surface of the metal matrix composite insert and the opposing inner peripheral surface of the recess that surrounds the metal matrix composite insert.

9. A method according to claim 8, further comprising moving the probe along the lateral side of the recess.

10. A method according to claim 9, in which moving the probe comprises following a path at least partially around a perimeter of the recess.

11. A method according to claim 9, further comprising maintaining the probe at a constant insertion depth when moving the probe along the lateral side of the recess.

12. A method according to claim 1, further comprising removing any excess material from the weld which projects proud of the first surface.

13. A method according to claim 7, in which friction stir welding comprises introducing a probe of a rotating tool into the metal body through a second surface thereof, spaced from and opposite the first surface of the metal body, to form a weld between an underside surface of the metal matrix composite insert and a bottom surface of the recess.

14. A method according to claim 13, further comprising moving the probe underneath the recess, from one side of the bottom surface of the recess to another side of the bottom surface of the recess.

15. A method according to claim 13, in which friction stir welding comprises maintaining the probe at a constant insertion depth when moving the probe underneath the recess.

16. A method according to claim 15, in which the constant insertion depth is maintained to prevent the probe penetrating the recess.

17. A method according to claim 1, further comprising covering the first surface of the metal body with a metal plate to conceal the metal matrix composite insert between the metal body and the metal plate, once the metal matrix composite insert has been introduced into the recess.

18. A method according to claim 17, further comprising welding the metal plate to the metal body and/or the metal matrix composite insert.

19. A selectively reinforced component comprising a metal body with a metal matrix composite insert embedded in a first surface of the metal body, with at least one weld bonding an outer surface of the metal matrix composite insert to the metal body.

20. A selectively reinforced component according to claim 19, in which the at least one weld comprises a weld formed at the first surface of the metal body and which extends below the first surface of the metal body.

21. A selectively reinforced component according to claim 20, in which the weld extends below the first surface of the metal body to a depth at least equal to a depth to which the metal matrix composite insert is embedded in the first surface of the metal body.

22. A selectively reinforced component according to claim 21, in which the weld surrounds the metal matrix composite insert.

23. A selectively reinforced component according to claim 19, in which the at least one weld comprises a weld formed or exposed at a second surface of the metal body, the second surface being spaced from and opposite the first surface, with the weld formed or exposed at the second surface extending through the metal body to the metal matrix composite insert embedded in the metal body.

24. A selectively reinforced component according to ny claim 19, in which an upper surface of the metal matrix composite insert embedded in the metal body is flush with the first surface of the metal body.

25. A selectively reinforced component according to claim 24, in which the upper surface of the metal matrix composite insert is covered by a metal plate.

26. A selectively reinforced component according to claim 25, in which the metal plate is welded to the metal body and/or the metal matrix composite insert.

27. A selectively reinforced component according to claim 19, in which the metal matrix composite insert comprises a continuous (monofilament or multifilament) reinforcement.

28. A selectively reinforced component according to claim 27, in which the continuous reinforcement comprises at least one filament aligned in a common direction which is substantially parallel to the first surface of the metal body.

29. A selectively reinforced component according to claim 28, in which the metal body is circular, with at least one filament aligned in a radial direction relative to the circular metal body.

30. A selectively reinforced component according to claim 29, in which the metal matrix composite insert is one of a plurality of metal matrix composite inserts embedded in the first surface of the metal body, with each of the metal matrix composite inserts comprising a continuous reinforcement, with at least one filament of each metal matrix composite aligned in a radial direction relative to the circular metal body.

31. A selectively reinforced component according to claim 30, in which the plurality of metal matrix composite inserts embedded in the first surface of the metal body are evenly spaced in a circumferential direction relative to the circular metal body.

32. A metal matrix composite insert for selectively reinforcing a metal body, the metal matrix composite insert comprising a core region comprising a continuous reinforcement and a marginal region which is metal-rich compared the core region.

33. A metal matrix composite insert according to claim 32, in which the marginal region surrounds the core region in at least one plane.

34. A metal matrix composite insert according to claim 32, in which the marginal region is substantially free of reinforcement filaments and/or fibres.

35. A metal matrix composite insert according to claim 32, in which the marginal region extends to a depth of up to 5 mm in a at least one direction from an outer surface of the metal matrix composite insert towards the core region.
